(19) United States
(12) Patent Application Publication
(10) Pub. No.: US 2006/0191008 A1
(43) Pub. Date: Aug. 24, 2006

(54) Apparatus and method for accelerating intrusion detection and prevention systems using pre-filtering

(75) Inventors: Amila Fernando, Pennant Hills (AU); Anthony Place, Waterloo (AU); Simon Ratner, Kensington (AU); Teewoon Tan, Roseville (AU); Darren Williams, Newtown (AU); Robert Matthew Barrie, Double Bay (AU); Stephen Gould, Killara (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sensory Networks Inc., Palo Alto, CA (US)

(21) Appl. No.: 11/291,530

(22) Filed: Nov. 30, 2005

Related U.S. Application Data
(60) Provisional application No. 60/632,240, filed on Nov. 30, 2004.

(51) Int. Cl. G06F 12/14

(52) U.S. Cl. 726/23

(57) ABSTRACT

An accelerated network intrusion detection and prevention system includes, in part, first, second and third processing stages. The first processing stage receives incoming packets and generates, in response, first and second processed data streams using a first set of rules. The first processing stage optionally detects whether the received packets are suspected of attacking the network and places the received data packets in the first processed data stream. The second processing stage receives the first processed data stream and generates, in response, a third processed data stream using a second set of rules. The second processing stage optionally classifies the first processed data stream, that is suspected of launching a network attack, as either attacks or benign network traffic. A third processing stage receives and processes the second and third processed data streams.

### CROSS-REFERENCES TO RELATED APPLICATIONS

The present application claims benefit under 35 USC 119(e) of U.S. provisional application No. 60/632240, file Nov. 30, 2004, entitled “Apparatus and Method for Acceleration of Security Applications Through Pre-Filtering”, the content of which is incorporated herein by reference in its entirety.

The present application is also related to copending application Ser. No. ______, entitled “Apparatus And Method For Acceleration Of Security Applications Through Pre-Filtering”, filed contemporaneously herewith, attorney docket no. 021741-001810US; copending application Ser. No. ______, entitled “Apparatus And Method For Acceleration Of Electronic Message Processing Through Pre-Filtering”, filed contemporaneously herewith, attorney docket no. 021741-001820US; copending application Ser. No. ______, entitled “Apparatus And Method For Acceleration Of Malware Security Applications Through Pre-Filtering”, filed contemporaneously herewith, attorney docket no. 021741-001830US; all assigned to the same assignee, and all incorporated herein by reference in their entirety.

### BACKGROUND OF THE INVENTION

Electronic communication over a network or series of networks is a critical enabling technology for a diverse range of commercial and social interactions. The recent rapid expansion of the Internet has triggered the wide-spread use of applications that offer services such as the sending and receiving electronic messages, the querying of large online information databases and software, music and video distribution.

As more systems are connected to these networks and more services are utilized, the amount of traffic being carried on the networks increases. Furthermore, once connected to a network, a system is vulnerable to malicious attack from other connected systems. The two main potential attacks are Denial of Service (DoS) and unauthorized remote access.

A DoS attack aims to reduce the availability of a service or system. One such attack may include sending large volumes of traffic such that the system under attack is unable to efficiently process all incoming traffic and subsequently delays or discards non-malicious traffic. Another such attack sends specially constructed packets designed to limit the systems effectiveness though various mechanisms, including causing the system throughput to reduce though exacting use of processing or storage resources or causing the software to fail. These attacks are particularly harmful when the system provides essential services such as managing power distribution, hospitals and national security.

Attacks that enable unauthorized remote access to systems and services can also cause substantial damage. In an increasingly information-based world, restricting access to sensitive information is critical both in preserving intellectual property or privacy and minimizing commercial exposure to losses such as identity fraud.

Hybrid attacks are also possible in which a worm gains unauthorized remote access to a system, and then attempts to gain unauthorized remote access to many more systems, indirectly causing a DoS attack. Two such examples are the Code Red worm which emerged in 2001 and, at its peak, infected 2,000 new systems per minute and the Sapphire worm which emerged in 2002 and spread nearly two orders of magnitude faster, significantly slowing down or disabling a large fraction of the Internet.

Most modem networks, including the Internet, send data in discrete units known as packets. Each packet comprises a header and a payload. The header contains meta-data defining required or allowed variables for the active communication protocols. The payload contains a fraction of the original file or message to be transmitted. Given receipt of a sufficient number of packets, the original file or message can be reconstructed by aggregation of the respective payloads.

Most networks send packets over a medium that is shared by more than one system. Packets are routed according to variables defined in their respective headers such that at each hop in the network, only a fraction of the header, and none of the payload, needs to be processed by the routing network elements. This simplicity ensures that such networks are scalable, and is a significant contributing factor to the rapid expansion of the Internet. However, in order to accurately detect malicious packets, the entire packet, including both the header and the payload, must be processed.

Network intrusion detection systems (IDS) aim to analyze all packets in a network, detect malicious packets and inform other systems or users of the detections. Network intrusion prevention systems (IPS) aim to analyze all packets in a network, detect malicious packets, inform other systems or users of the detections and, in addition, remove all malicious packets from the network. Potentially malicious attacks are detected within IDS and IPS systems by matching rules. To ensure that systems are protected against all previously encountered malicious attacks, rules that detect newly discovered attacks are always appended to the previous set of rules.

FIG. 1 depicts a prior art IDS system. Each input packet is read by network device 110 from transmission medium 160 and routed to intrusion detection system 120 that processes the packet using rules from rule database 130. The rule database 130 comprises rules describing packet characteristics, derived properties, signature patterns, relationships between said characteristics and signature patterns, and relationships between rules. Merely as an example, packet characteristics include packet headers, protocol identifiers, traffic flow identifiers or properties and so on and so forth. Derived properties can be calculated CRC (cyclic redundancy check) values, destination routes, and so on and so forth. Signature patterns can be literals or regular expressions. If the packet is found to be malicious, a detection message is sent to the alerting and logging system 140.

FIG. 2 depicts a prior art IPS system. Each input packet is read and removed from transmission medium 205 by first network device 210 and routed to intrusion prevention system 220 that processes the packet using rules from rule database 230. If the packet is found to be malicious, a detection message is sent to alerting and logging system 250. If the packet is found not to be malicious, it is routed to second network device 240 that inserts it back into the network through transmission medium 270.

Both IDS system 100 and IPS system 200 are slow as they are unable to scale to handle increasing traffic load facilitated by fast network speeds commonly found in modern networks. Additionally, these systems are unable to scale to handle large numbers of rules. Furthermore, the number of rules required to detect exploits is rapidly increasing with the growth in the number of new exploits. There is a need for a system and methodology to increase the speed of detecting and protecting against malicious attack, such that high network traffic loads can be effectively processed using large numbers of rules, minimizing the damage caused by attacks.

### BRIEF SUMMARY OF THE INVENTION

In accordance with the present invention, a network intrusion detection system includes, in part, first, second and third processing stages. The first processing stage is configured to receive and process received network packets to generate one of at least a first or second processed data streams using a first set of rules. In an embodiment, the first processing stage is further configured to detect one or more suspected network attacks using the received network packets. The network packets are included in the transmitted first processed data stream, which are processed and further verified by the second processing stage. The second processing stage is configured to receive the first processed data stream and to generate, in response, a third processed data stream using a second set of rules.

In an embodiment, the second processing stage is further configured to classify the first processed data stream--suspected as containing network attacks--as either attacks or benign network traffic. A third processed data stream is generated and transmitted to the third processing stage. The third processing stage is configured to receive and process the second processed data stream from the first processing stage and to receive and process the third processed data stream from the second processing stage.

In an embodiment of the invention, a network intrusion prevention system includes, in part or in entirety, the modules disposed in the network intrusion detection system as well as an output module coupled to the first and second processing stages. In such embodiments, the first processing stage is further configured to generate a fourth processed data stream and the second processing stage is further configured to generate a fifth processed data stream. The output module is configured to receive and process the fourth and fifth processed data streams to generate one or more output network packets. The first processing stage directs one or more benign input network packets to the output module.

In an embodiment, the output module is further configured to derive commands from the fourth and fifth processed data streams, where a corresponding first processing stage is further configured to derive a first meta data from the input network packets. The first meta data is included in the fourth processed data stream. A corresponding second processing stage is further configured to derive a second meta data from the first processed data stream. The second meta data is included in the fifth processed data stream. The derived commands are included in the output network packets. The commands control the flow of network packets received by the first processing stage.

In an embodiment, the system is configured to discard network packets classified as attacks. In another embodiment, the network intrusion prevention system is configured to discard network packets classified as attacks.

In an embodiment, the third processing stage includes, in part, one or more memory segments provided in one or more memory devices. In such embodiments, a corresponding first processing stage is further configured to transmit and store the second processed data stream in the memory segments, and a corresponding second processing stage is further configured to transmit and store the third processed data stream in the memory segments.

In an embodiment, the network intrusion detection or prevention system includes a reporting module coupled to the first and second processing stages, where the first processing stage is further configured to generate a sixth processed data stream. The second processing stage is further configured to generate a seventh processed data stream and the reporting module is further configured to receive the sixth and seventh processed data streams. The reporting module processes the sixth and seventh processed data streams to generate a network security report.

In an embodiment, the second processing stage in a network intrusion detection or prevention system is further configured to derive an eighth processed data stream from the first processed data stream and the second set of rules. This second processing stage is configured to transmit the eighth processed data stream to the first processing stage. The first processing stage then classifies one or more input network packets as benign or attack packets using the commands and meta data included in the eight processed data stream.

In an embodiment, the first set of rules is derived from the second set of rules. Rules may include literals and regular expression patterns. Rules may also be defined by network and packet characteristics and properties derived from network and packet characteristics.

In another embodiment, the first processing stage is further configured to identify the received input network packets as belonging to one or more streams, and store the one or more input network packets in the corresponding memory segments.

In an embodiment, the first processing stage is further configured to perform processing on the received input network packets using hardware logic. In another embodiment, the hardware logic is reconfigurable, such as in a field programmable gate array (FPGA). The hardware logic may be configured to perform pattern and content processing.

### BRIEF DESCRIPTION OF THE DRAWINGS

FIG. 1 Depicts a system for intrusion detection, as known in the prior art.

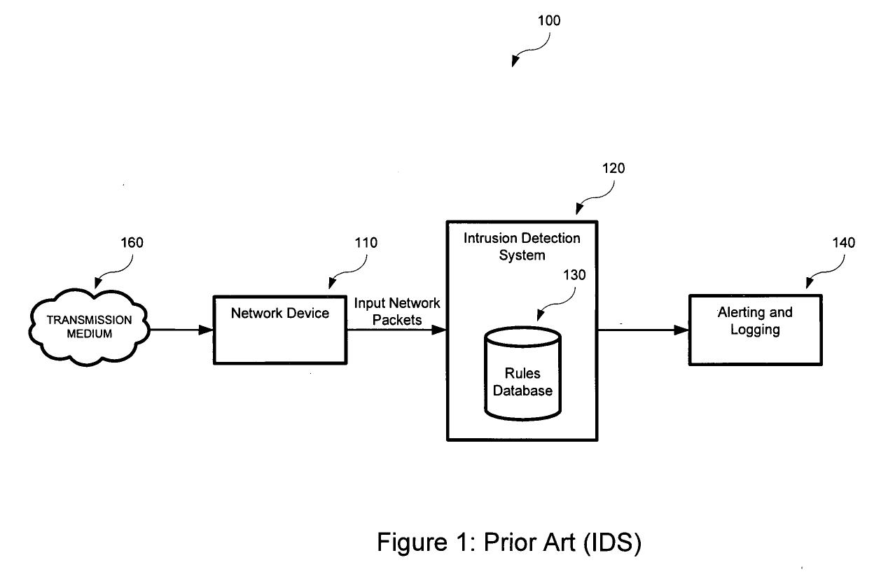

FIG. 2 Depicts a system for intrusion prevention, as known in the prior art.

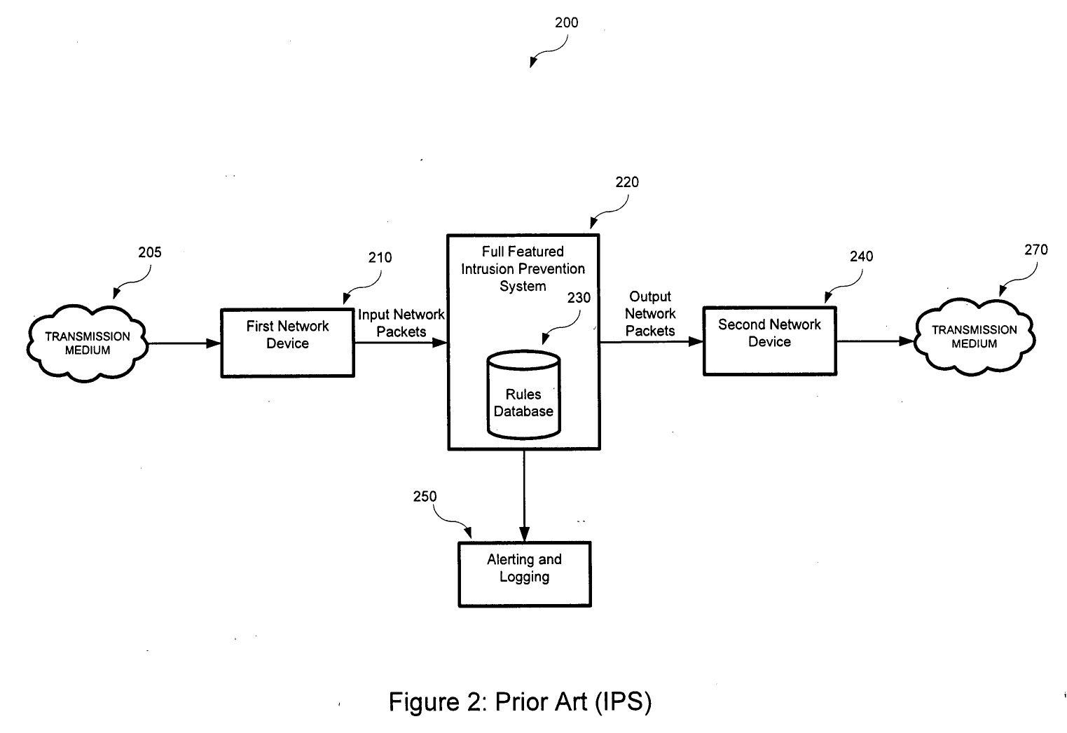

FIG. 3 Shows an intrusion detection system utilizing a pre-filter, in accordance with an embodiment of the present invention.

FIG. 4 Shows an intrusion prevention system utilizing a pre-filter, in accordance with an embodiment of the present invention.

FIG. 5 Shows an intrusion prevention system utilizing a pre-filter, in accordance with another embodiment of the present invention.

FIG. 6 Shows a flow chart for packet processing disposed in an intrusion prevention system utilizing a pre-filter, in accordance with an embodiment of the present invention.

FIG. 7 Shows an intrusion prevention system utilizing a pre-filter, in accordance with an embodiment of the present invention.

FIG. 8 Shows a flow chart for a method generating the required rule sets, in accordance with an embodiment of the present invention.

### DETAILED DESCRIPTION OF THE INVENTION

Exemplary embodiments of the present invention are now described in detail. Referring to the drawings, like numbers indicate like parts. As used in herein, the meaning of “a”, “an”, and “the” includes plural reference, unless the context clearly dictates otherwise. Finally, as used herein, the meanings of “and” and “or” include both the conjunctive and disjunctive and may be used interchangeably unless the context clearly dictates otherwise.

In accordance with an exemplary embodiment of the present invention, a pre- filtering stage classifies incoming data elements, produces further information from the classification or data element transformation, and transmits the original or produced data elements to appropriate processing modules. Accordingly, the overhead in handling data elements not appropriate for a particular processing module is reduced and improvement in throughput is achieved.

In accordance with an embodiment of the present invention, data elements from input streams are processed to produce one or more duplicate or modified data elements, which are output within selected data streams. To achieve this, a data stream pre-filter is used to receive and pre-filter the data, the output which is supplied to an IDS and EPS system. Accordingly, a scaleable system configured to combat the increasing throughput requirements of modem communication systems is provided.

Data elements are applied to the system within a data stream which can contain the original network packet, meta data about the packet and control information for managing or informing a downstream module. Data elements within an incoming stream are processed within a receiving module to categorise the data element, including the application of a rule set. The categorised data elements are further processed according to their category, by providing new data elements, in some embodiments, and transmitting the data elements within selected output streams or deletion of the data elements, as described further below.

In accordance with an embodiment of the present invention, data elements from input streams can be processed and transformed to produce derived data elements. For example, such derivations may involve normalising input network packets to a standardised format or attaching meta data to the input network packets.

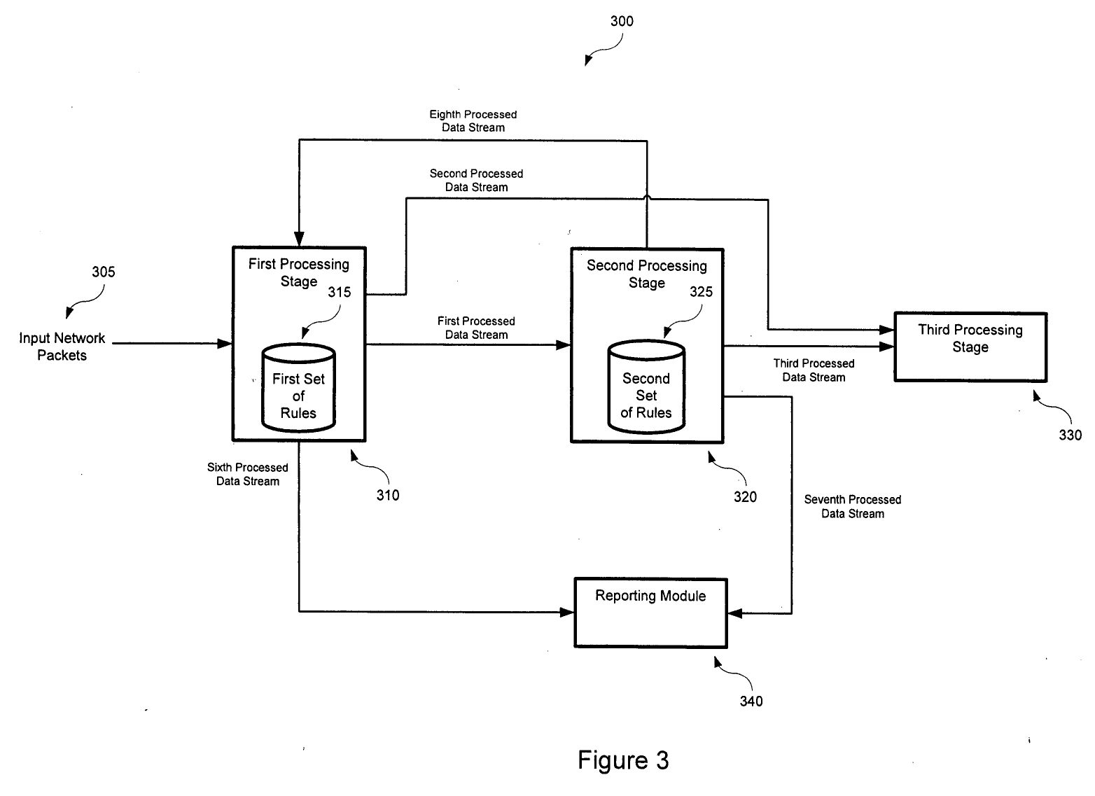

FIG. 3 shows various logic blocks of a system 300 configured to accelerate intrusion detection, in accordance with an embodiment of the present invention. First processing stage 310 uses the first set of rules 315 to classify one or more input network packets 305 into one or more categories. Input network packets 305 are copied and routed to first processing stage 310. First processing stage 310 receives the eighth processed data stream. The eight processed data stream contains feedback information and command meta data, and is processed to affect the operation or interpretation of the input network packets 305 or first set of rules 315.

In an embodiment, the categories are divided into suspicious traffic, benign traffic and attack traffic. In another embodiment, the categories are divided into suspicious traffic and benign traffic. First processed data stream, comprising classified suspicious traffic, is routed to second processing stage 320. Second processed data stream, comprising classified attack traffic is routed to third processing stage 330. Sixth processed data stream, comprising decision and error feedback from first processing stage 310 is routed to reporting module 340. In another embodiment, first processing stage 310 does not output sixth processed data stream.

Second processing stage 320 uses second set of rules 325 to classify packets from first processed stream into two categories. In an embodiment, the categories are divided into benign traffic and attack traffic. Third processed data stream, comprising classified benign and attack traffic, is routed to third processing stage 330. Seventh processed data stream, comprising decision and error feedback from second processing stage 320 is routed to reporting module 340. In another embodiment, second processing stage 320 does not output seventh processed data stream. Eighth processed data stream, comprising decision and error feedback from second processing stage 320 is routed to first processing stage 310. In another embodiment, second processing stage 320 does not output eighth processed data stream. In an embodiment, the second processing stage 320 is a full featured intrusion detection system.

In an embodiment, third processing stage 330 discards packets from third processed data stream and second processed data stream and releases any resources used by these packets. In another embodiment, the functions performed by third processing stage 330 may be replicated and performed in each preceding processing stage, i.e., the first processing stage 310 and the second processing stage 320.

In an embodiment, reporting module 340 processes incoming processed data streams to produce a network security report. The network security report may include alert and logging information. Merely as an example, reporting module 340 can produce or send information to alert or notify an operator that an attack has been detected by system 300. As an example, the logging information can be the processed data stream processed and transformed into a human readable format. In such an example, the logging information can be stored on a physical storage device, such as a hard disk. Equivalent feedback mechanisms can be achieved though alternative paths, such as via the reporting module or any other module within or additional to the system.

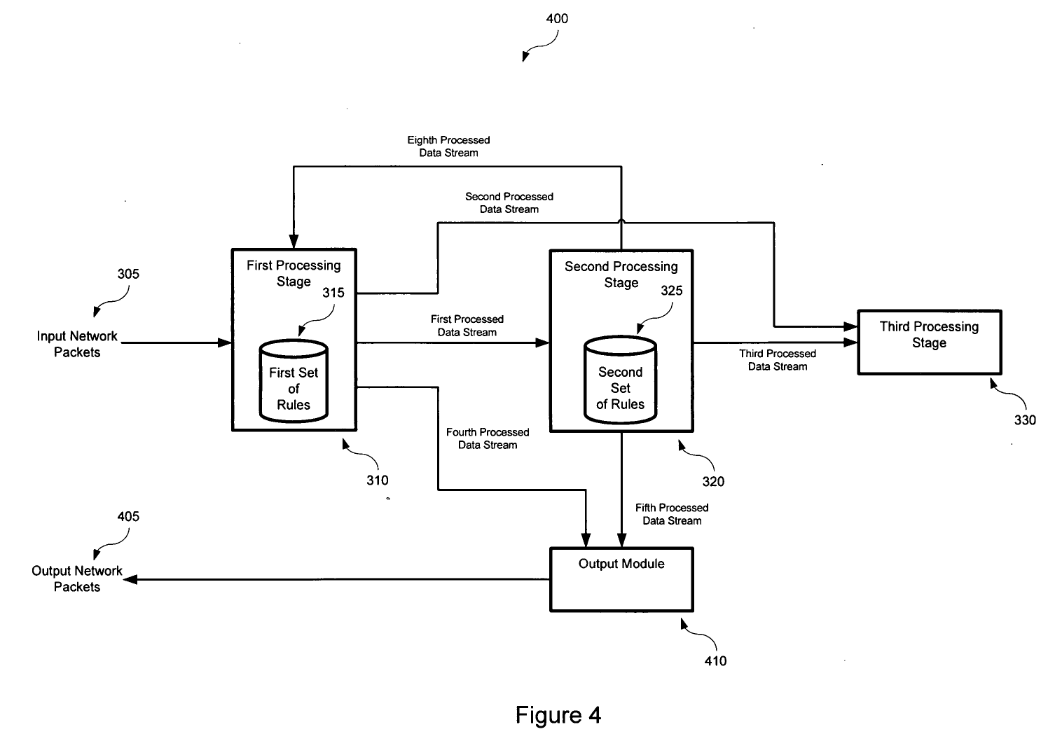

FIG. 4 shows various logic blocks of a system 400 configured to accelerate intrusion detection, in accordance with another embodiment of the present invention. Input network packets 305 are removed from network and routed to first processing stage 310. First processing stage 310 receives the eighth processed data stream. The eight processed data stream contains feedback information and command meta data and is processed to affect the operation or interpretation of the input network packets 305 or first set of rules 315. First processing stage 310 uses first set of rules 315 to classify one or more input network packets 305 into one or more categories. In an embodiment, the categories are divided into suspicious traffic, benign traffic and attack traffic. In another embodiment, the categories are divided into suspicious traffic and benign traffic. First processed data stream, comprising classified suspicious traffic, is routed to second processing stage 320. Second processed data stream, comprising classified attack traffic is routed to third processing stage 330. Fourth processed data stream, comprising classified benign traffic is routed to output module 410.

Second processing stage 320 uses second set of rules 325 to classify packets from first processed data stream into two categories. In an embodiment, the categories are divided into benign traffic and attack traffic. Third processed data stream, comprising classified attack traffic, is routed to third processing stage 330. Fifth processed data stream, comprising classified benign traffic is routed to output module 410. Output module 410 receives fourth processed data stream and fifth processed data stream and creates output network packets 405. In another embodiment, the second processing stage 320 produces an eighth processed data stream routed to the first processing stage 310. This eighth processed data stream comprises feedback information and command meta data. In an embodiment, the second processing stage 320 is a full featured intrusion detection system.

In an embodiment, third processing stage 330 discards packets from third processed data stream and second processed data stream and releases any resources used by these packets. In another embodiment, the functions performed by third processing stage 330 could be replicated and performed in each preceding processing stage, e.g., the first processing stage 310 and the second processing stage 320.

Output module 410 receives data from the fourth processed data stream and fifth processed data stream and produces output network packets 405 for transmission. Equivalent feedback mechanisms can be achieved though alternative paths, such as via the reporting module or any other module within or additional to the system.

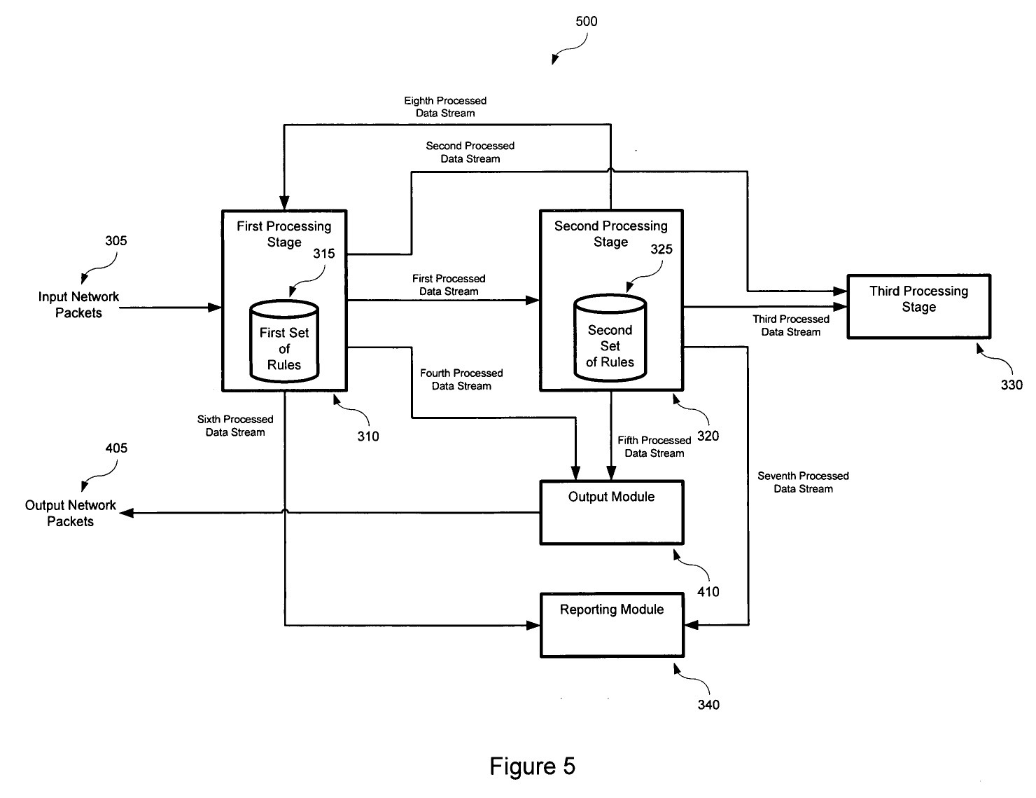

FIG. 5 shows logic blocks of a system 500 that accelerates intrusion prevention, in accordance with an embodiment of the present invention. Input network packets 305 are removed from network and routed to first processing stage 310. First processing stage 310 uses first set of rules 315 to classify one or more input network packets 305 into one or more categories. In an embodiment, the categories are divided into suspicious traffic, benign traffic and attack traffic. In another embodiment, the categories are divided into suspicious traffic and benign traffic. First processed data stream, comprising classified suspicious traffic, is routed to second processing stage 320. Second processed data stream, comprising classified attack traffic is routed to third processing stage 330. Fourth processed data stream, comprising classified benign traffic is routed to output module 410. Sixth processed data stream, comprising decision and error feedback from first processing stage 310 is routed to reporting module 340. In an embodiment, reporting module 340 processes incoming processed data streams to produce a network security report. Merely as an example, reporting module 340 can produce or send information to alert or notify an operator that an attack has been detected by system 500.

Second processing stage 320 uses second set of rules 325 to classify packets from first processed data stream into two categories. In an embodiment, the categories are divided into benign traffic and attack traffic. Third processed data stream, comprising classified attack traffic, is routed to third processing stage 330. Fifth processed data stream, comprising classified benign traffic is routed to-output module 410. Output module 410 receives fourth processed data stream and fifth processed data stream and creates output network packets 405. Seventh processed data stream, comprising decision and error feedback from second processing stage 320 is routed to reporting module 340. In another embodiment, second processing stage 320 may not output seventh processed data stream.

In an embodiment, the second processing stage 320 is a full featured intrusion detection system. In an embodiment, third processing stage 330 discards packets from third processed data stream and second processed data stream and releases any resources used by these packets. In another embodiment, the functions performed by third processing stage 330 could be replicated and performed in each preceding processing stage, e.g., the first processing stage 310 and the second processing stage 320.

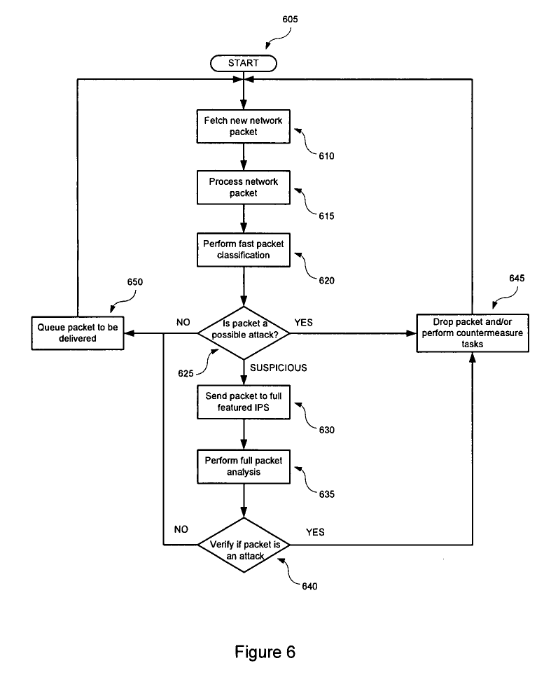

FIG. 6 is a flow chart that depicts the packet processing for an intrusion prevention process in an embodiment of the present invention. The process begins in step 605 by initializing the system. The process continues at step 610 where a new packet is fetched from the network. This packet is then processed at step 615, and classified at step 620. In an embodiment, traffic classifications include attack, possible attack and benign. Step 625 checks the classification. If the data stream is an attack, it is further processed at step 645. If the data stream is a possible attack, it is further processed at step 630. If the data stream is classified as benign, it is further processed at step 650. The packet is sent to a full featured IPS in step 630 which performs a full data stream analysis in step 635. If the data stream is confirmed to be an attack in step 640, it is further processed at step 645. If the data stream is confirmed as not an attack, it is further processed at step 650. At step 650, the traffic is queued to be delivered back to the network and the process returns to step 610. At step 645, countermeasure tasks are performed to prevent the detected intrusion. In an embodiment, the data stream is dropped. The process then returns to step 610.

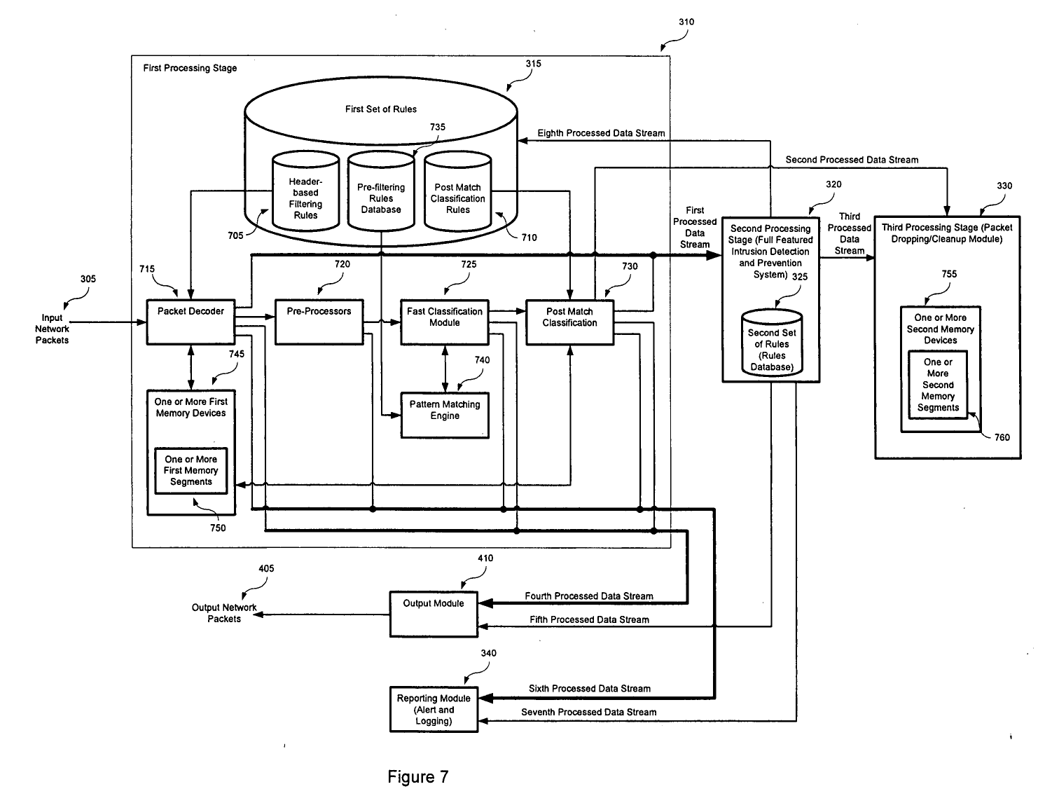

FIG. 7 illustrates a system 700 adapted to provide both intrusion detection and intrusion prevention; in accordance with another embodiment of the present invention. In system 700, input network packets are received by first processing stage 310. The first processing stage further includes, in part, a packet decoder 715, a multitude of pre-processors 720, fast classification module 725, pattern matching engine 740, post match classification module 730, a first set of rules 315 which in turn further comprises header based filtering rules 705, pre-filtering rules database 735 and post match classification rules 710. Second processing stage 320, third processing stage 330, reporting module 340 and output module 410 are described previously.

Referring to FIG. 7, the second processing stage 320 is adapted to provide the functionality of a full featured intrusion detection and prevention. The third processing stage 330 is adapted to provide packet dropping and resource cleanup. Furthermore, the reporting module 340 is adapted to provide alerting and logging functionality. Output module 410, which may be a second network device, is coupled to a transmission medium 270 and allows the system 700 to re-inject output network packets back into the transmission medium. The second network device may be the same as the first network device as indicated by block 210 or may be a different network device.

In such embodiments, the combined processes within the first processing stage are configured to classify one or more input network packets at a faster rate than conventional intrusion detection and prevention system. The first processed data stream output by the first processing stage may include a smaller subset of all the input network packets, and consequently the second processing stage deals with less input network packets than the first processing stage. Consequently, the present invention processes network packets faster than conventional systems.

Referring to FIG. 7, packet decoder 715 receives input network packets from the first network device 210. The packet decoder is configured to process input network packets and generate and transmit one or more data streams to the pre-processors 720, reporting module 340, output module 410 or second processing stage 320. The packet decoder decodes each incoming network packet and further classifies the decoded packet according to header based filtering rules 705 as attacks, benign traffic, suspicious traffic or traffic requiring further processing. Input network packets classified as attacks are routed to the reporting module 340 and included in the sixth processed data stream. Furthermore, input network packets classified as suspicious traffic are routed to the second processing stage 320 and included in the first processed data stream. Furthermore, input network packets classified as benign traffic are routed to the output module 410 and included in the fourth processed data stream. Furthermore, the packet decoder may classify one or more input network packets as belonging to one of a multitude of input packet streams. For example, the packet decoder may use the transmission control protocol (TCP) characteristics such as the 5-tuple to generate a hash value to identify input network packets as belonging to a unique input packet stream. Furthermore, the packet decoder can store such identified input network packets into one or more first memory segments 750 belonging to the correspondingly identified input packet stream. Merely as an example, said first memory segments can be configured as a linear fixed length arrays or a series of circular buffers.

Reference numeral 720 represents a multitude of pre-processors coupled to the packet decoder from which decoded packets are received and further processed to produce associated meta data, or are transformed into a new pre-processed data stream and routed to the fast classification module 725. Furthermore the pre-processors may also classify input network packets as attacks and route such traffic to the reporting module 340. Furthermore the pre-processed data stream that is produced by the pre-processor may also include the unchanged input decoded packets.

Fast classification module 725 is coupled to the pre-processors 720, pattern matching engine 740, post match classification 730, output module 410 and reporting module 340. The fast classification module receives a pre-processed data stream from the pre- processors 720 and transmits a pre-matching data stream to the pattern matching engine 740. This pre-matching data stream may be the original pre-processed data stream or a transformation or part of the pre-processed data stream. Furthermore, the fast classification module receives as input a matching data stream from the pattern matching engine. Upon receipt of the matching data stream, the fast classification module quickly classifies the pre- processed data stream into one of a first suspected data stream, benign traffic, or attacks. First suspected data stream and attacks are routed to the post match classification module 730. Benign traffic is routed to the output module 410; and attacks are routed to the reporting module 340.

Pattern matching engine 740 is coupled to the fast classification module and receives a pre-matching data stream from the fast classification module as input. The pattern matching engine searches incoming pre-matching data stream for rules as specified in the pre-filtering rules database and produces match information that is transmitted to the fast classification module included in the matching data stream. For example, the matching data stream can contain information such as patterns or rules that have matched in the pre- matching data stream, locations that a match may have occurred in the data stream, or an aggregate of matching information. Furthermore the pattern matching engine may make use of specialised hardware to perform fast pattern matching. As a further example, the specialised hardware can use rules contained in the pre-filtering rules database 735 to perform fast pattern and content matching. As another example, the pre-filtering rules database 735 may include, in part, content literals and regular expressions which can be loaded onto specialised hardware to perform fast pattern and content matching. Furthermore, the pattern matching engine using reconfigurable hardware reconfigurable, such as in a field programmable gate array (FPGA).

Post match classification module 730, is coupled to the fast classification module 725, the second processing stage 320, the third processing stage 330, the output module 410 and the reporting module 340. The post match classification module will receive as input a first suspected data stream and using post match classification rules 710 will further classify the first suspected data stream into one of a second suspected data stream, benign traffic, attacks and a cleanup data stream. Furthermore, the generated data streams are routed to the second processing stage 320, output module 410, reporting module 340 and the third processing stage 330 respectively. In an exemplary embodiment, the post match classification step may involve detecting if an input network packet that matched a specific pattern in the pre-filtering rules database, e.g. rule A, further belongs to a network port group that is specified in post match classification rules associated with rule A. The second suspected data stream supplied by the post match classification module can include the original input network packets, transformed data and meta data, and is included in the first processed data stream. For example the meta data included in the first processed data stream comprises detection results, which further comprises match information, match locations and match frequency and statistics or other data that can be used by the full featured intrusion detection and prevention system in its processing to improve performance. In an exemplary embodiment, the transformed data included in the first processed data stream can be re- assembled input network packets or re-ordered input network packets. In another embodiment, one or more modules within the first processing stage may transmit data on the first, second, fourth and sixth data streams.

Referring to FIG. 7, the second processing stage 320 is adapted to provide the functionality of a full featured intrusion detection and prevention system and receives as input a suspected data stream contained in the first processed data stream. The full featured intrusion detection and prevention system, making use of a second set of rules 325, will then further classify the suspected data stream as either attacks, benign traffic, cleanup traffic, or a feedback data stream; the data streams are routed to the reporting module 340, output module 410, third processing stage 330 and the first set of rules 315 respectively.

The detected attacks will be included as part of the seventh processed data stream, the benign traffic included in the fifth processed data stream, the cleanup traffic included in the third processed data stream and the feedback data stream included in the eight processed data stream. The feedback data stream comprising of commands, information that can add, remove or alter any part of the first set of rules within the first processing stage can alter the behaviour of the first processing stage 310. As merely an example, the feedback data can inform the first processing stage 310 to drop all future packets belonging to an identified stream. As merely another example, the feedback data can emit a command to the first processing stage 310 to modify an existing rule in the first set of rules 315. As merely another example, the feedback data can add a new rule to the first set of rules 315.

The first set of rules 315 can be derived from the second set of rules 325. In an exemplary embodiment, the derivation process involves extracting content literals from the second set of rules 325. In another exemplary embodiment, the derivation process involves extracting literals, regular expressions, or header rules or packet characteristics with the aid of heuristics to minimise false positive matches in the first processing stage 310.

Output module 410 is further configured to derive commands from the fourth and fifth processed data streams. Such commands are included in the output network packets and control the flow of network packets received by the first processing stage 310. For example, the second processing stage 320 can include a command to specify a particular TCP connection as being malicious and to require termination in the fifth processed data stream. The output module 410 can implement a termination sequence to be injected into the network contained in the output network packets to signal a termination of the said TCP connection.

Referring to FIG. 7, the third processing stage 330 is adapted to provide packet dropping functionality and resource cleanup. In this embodiment, the third processing stage 330 includes one or more second memory segments 760 within one or more second memory devices 755. Furthermore, the first processing stage 310 is configured to transmit and store the second processed data stream in the said second memory segments 760, and the second processing stage 320 is further configured to transmit and store the third processed data stream in the said second memory segments 760. Upon receipt of the first or second processed data streams, the third processing stage 330 can free up or reallocate the resources used by the first or second processed data streams and associated data within the system. For example, the third processing stage 330 can free all memory occupied by the said input network packets and associated meta data. As another example, the third processing stage 330 can structure the second memory segments 760 as a circular buffer such that no memory allocation or reallocation is required. In this example, the third processing stage 330 can direct the system to simply overwrite existing second memory segments 760 when required.

Referring to FIG. 7, in this embodiment, rules are provided to various modules within the first processing stage 310. It is important for optimal performance of the invention that the rules applied to each module are suitable for the application provided by that module. Original rule sets are provided and form a database of rules which are compiled, analyzed, processed to produce a first set of rules 315 and a second set of rules 325, which are further assigned to various modules within the first processing stage 310 and second processing stage 320. A rule could be applied as a whole to a module or processed to generate multiple rules which are configured for their target module.

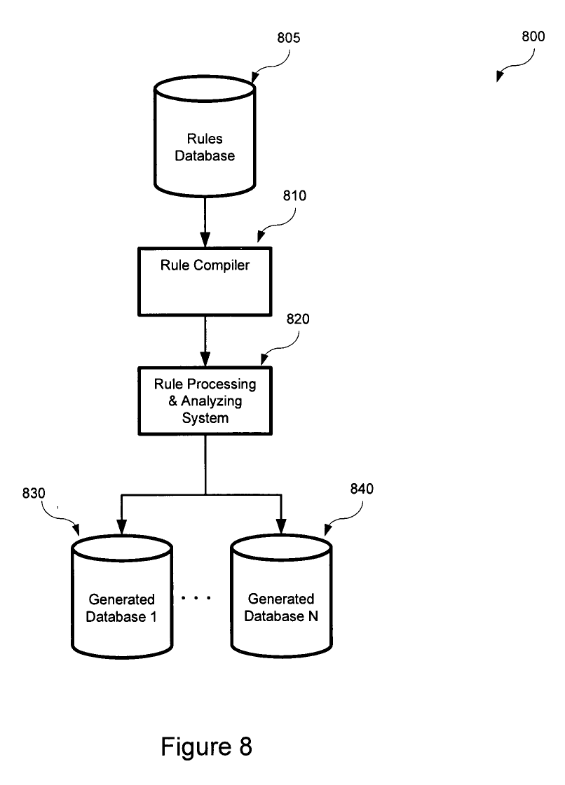

FIG. 8 is a flow chart 800 for a method generating the required rule sets, in accordance with an embodiment of the present invention. This method takes as input a rule database 805 that includes of sets of rules in any format. In this embodiment, the rule compiler 810 compiles the rule from the rule database 805. The compiled output is then further processed and analyzed within the rule processing and analyzing system 820 to produce one or more new rule sets 830 and 840.

In an alternative embodiment, the rule processing and analyzing system 820 can be placed before the rule compiler 810. In another alternative embodiment, separate rule processing and analyzing systems 820 could be placed before and after the rule compiler 810.

An example of this process is the analysis of rules related to confirming that network data conforms to a network protocol which can be applied to specific pre-filtering modules such as a packet decoder. In this example, the analysis step can extract network protocol information from the rule and include them in a new header based filtering rules database that is supplied to the packet decoder module. In another example, the processing of a rule that examines the content for a particular class of packet which can be converted to two rules, the first rule applied within a classification module and the second rule within a content matching module or secondary processing stage.

The rules typically require a compilation stage that transforms the original rule format to one that can be used by the target module. The analysis process and selection of rules can occur before, after or before and after a compilation stage.

The above embodiments of the present invention are illustrative and not limitative. Various alternatives and equivalents are possible. The described data flow of this invention may be implemented within separate networks of computer systems, or in a single network system, and running either as separate applications or as a single application. The invention is not limited by the type of integrated circuit in which the present disclosure may be disposed. Nor is the disclosure limited to any specific type of process technology, e.g., CMOS, Bipolar, or BICMOS that may be used to manufacture the present disclosure. Other additions, subtractions or modifications are obvious in view of the present disclosure and are intended to fall within the scope of the appended claims.

What is claimed is:

1. A network intrusion detection system comprising:
a first processing stage configured to receive and process one or more input network packets to generate one of at least a first or second processed data streams using a first set of rules;
a second processing stage configured to receive the first processed data stream and to generate in response a third processed data stream using a second set of rules; and
a third processing stage configured to receive and process the second processed data stream from the first processing stage and to receive and process the third processed data stream from the second processing stage.

2. The system of claim 1 wherein said first processing stage is further configured to detect one or more suspected network attacks using the received one or more input network packets, wherein said one or more input network packets are included in the transmitted first processed data stream, wherein the first processed data stream is transmitted to the second processing stage for further verification of the one or more suspected network attacks.

3. The system of claim 1 wherein said second processing stage is further configured to classify the first processed data stream that is suspected of comprising one or more network attacks as either attacks or benign network traffic.

4. The system of claim 1 wherein said second processing stage is further configured to route one or more segments of the first processed data stream to the third processing stage if the first processed data stream is classified as attacks.

5. The system of claim 1 wherein said third processing stage is further configured to discard the second and third processed data streams.

6. The system of claim 1 wherein said third processing stage comprises one or more second memory segments provided in one or more second memory devices, wherein said first processing stage is further configured to transmit and store the second processed data stream in the one or more second memory segments, wherein said second processing stage is further configured to transmit and store the third processed data stream in the one or more second memory segments.

7. The system of claim 1 further comprising:
an output module coupled to the first and second processing stages, wherein said first processing stage is further configured to generate a fourth processed data stream, wherein said second processing stage is further configured to generate a fifth processed data stream, wherein said output module is further configured to receive the fourth and fifth processed data streams, the output module being further configured to process the fourth and fifth processed data streams and generate one or more output network packets.

8. The system of claim 7 wherein said output module is further configured to derive commands from the fourth and fifth processed data streams, wherein said first processing stage is further configured to derive a first meta data from the input network packets, wherein said first meta data is included in the fourth processed data stream, wherein said second processing stage is further configured to derive a second meta data from the first processed data stream, wherein said second meta data is included in the fifth processed data stream, wherein said commands are included in the output network packets, wherein the commands control the flow of network packets received by the first processing stage.

9. The system of claim 1 further comprising:
a reporting module coupled to the first and second processing stages, wherein the first processing stage is further configured to generate a sixth processed data stream, wherein said second processing stage is further configured to generate a seventh processed data stream, wherein said reporting module is further configured to receive the sixth and seventh processed data streams, the reporting module being configured to process the sixth and seventh processed data streams, the reporting module being further configured to generate a network security report.

10. The system of claim 1 wherein said second processing stage is further configured to derive an eighth processed data stream from the first processed data stream and the second set of rules, the second processing stage being configured to transmit the eighth processed data stream to the first processing stage.

11. The system of claim 10 wherein said eighth processed data stream includes a first command and a first command meta data, wherein said first processing stage is configured to classify one or more input network packets as benign packets using the first command and first command meta data included in the eight processed data stream.

12. The system of claim 10 wherein said eighth processed data stream includes a second command and a second command meta data, wherein said first processing stage is configured to classify one or more input network packets as attack packets using the second command and second command meta data

13. The system of claim 1 wherein said first set of rules is derived from the second set of rules.

14. The system of 13 wherein said rules include literals and regular expression patterns.

15. The system of 13 wherein said rules are defined by network and packet characteristics and properties derived from network and packet characteristics.

16. The system of claim 1 wherein said first processed data stream includes one or more input network packets.

17. The system of claim 1 wherein said first processed data stream includes meta data.

18. The system of claim 1 wherein said first processed data stream includes one or more transformed network packets, wherein said first processing stage is further configured to generate one or more transformed network packets from the one or more input network packets.

19. The system of claim 9 wherein said second processing stage is further configured to generate classification results, wherein said classification results are included in the seventh processed data stream outputted by the second processing stage, wherein said reporting module is configured to generate a network security report using the classification results derived from the received seventh processed data stream, wherein said network security report comprises alert and logging information

20. The system of claim 9 wherein said first processing stage is further configured to generate detection results, wherein said detection results are included in the sixth processed data stream outputted by the first processing stage, wherein said reporting module is configured to generate a network security report using the detection results derived from the received sixth processed data stream, wherein said eighth processed data stream comprises alert and logging information.

21. The system of claim 7 wherein said first processing stage is further configured to detect one or more benign input network packets, wherein said one or more benign input network packets are included in the transmitted fourth processed data stream, wherein said fourth processed data stream is transmitted to the output module.

22. The system of claim 1 wherein said first processing stage is further configured to identify the one or more input network packets as belonging to one or more streams.

23. The system of claim 22 wherein said first processing stage further comprises one or more first memory segments provided in one or more first memory devices coupled to the first processing stage, wherein said first processing stage is further configured to store the one or more input network packets belonging to one or more streams into the one or more first memory segments, wherein the one or more input network packets stored in the one or more first memory segments are included in the first processed data stream generated by the first processing stage.

24. The system of claim 7 wherein said first processing stage is further configured to identify the one or more input network packets as belonging to one or more streams.

25. The system of claim 24 wherein the one or more input network packets stored in the one or more first memory segments are included in the fourth processed data stream generated by the first processing stage.

26. The system of claim 1 wherein said first processing stage is further configured to perform processing on the received one or more input network packets using hardware logic.

27. The system of claim 26 wherein said hardware logic is further configured to perform pattern and content processing.

28. The system of claim 26 wherein said hardware logic is reconfigurable.

29. A method for detecting network intrusion, the method comprising:
processing one or more input network packets at a first processing stage to generate one of at least a first or second processed data streams using a first set of rules;
generating a third processed data stream at a second processing stage from the first processed data stream and in accordance with a second set of rules; and
supplying the second and third processed data streams to a third processing stage.

30. The method of claim 29 further comprising:
detecting one or more suspected network attacks using the received one or more input network packets at the first processing stage; and
including in the transmitted first processed data stream the input network packets are included in the transmitted first processed data stream.

31. The method of claim 30 wherein said second processing stage is further configured to classify the first processed data stream that is suspected of comprising one or more network attacks as either attacks or benign network traffic.

32. The method of claim 31 wherein said second processing stage is further configured to route one or more segments of the first processed data stream to the third processing stage if the first processed data stream is classified as attacks.

33. The method system of claim 29 wherein said third processing stage is further configured to discard the second and third processed data streams.

34. The method of claim 29 further comprising:
storing the second and third processed data streams in a memory.

35. The method of claim 29 further comprising:
generating a fourth processed data stream;
generating a fifth processed data stream; and
generating one or more output network packets from said fourth and fifth processed data streams.

36. The method of claim 29 further comprising:
deriving a plurality of commands from the fourth and fifth processed data streams; the commands controlling the flow of network packets received by the first processing stage;
deriving a first meta data from the input network packets;
including the first meta data in the fourth processed data stream;
deriving a second meta data from the first processed data stream;
including the second meta data in the fifth processed data stream; and
including the commands in the output network packets.

37. The method of claim 29 further comprising:
generating a sixth processed data stream;
generating a seventh processed data stream generating a network security report using said sixth and seventh processed data streams.

38. The method of claim 29 further comprising:
deriving an eighth processed data stream from the first processed data stream and the second set of rules;
transmitting the eighth processed data stream to the first processing stage.

39. The method of claim 38 further comprising:
disposing a first command and a first command meta data in said eighth processed data; and
classifying one or more input network packets as benign packets using the first command and first command meta data.

40. The method of claim 38 further comprising:
disposing a second command and a second command meta data in said eighth processed data; and
classifying one or more input network packets as attack packets using the second command and second command meta data.

41. The method of claim 29 wherein the first set of rules is derived from the second set of rules.

42. The method of claim 41 wherein said rules include literals and-regular expression patterns.

43. The method of claim 41 wherein said rules are defined by network and packet characteristics and properties derived from network and packet characteristics.

44. The method of claim 29 wherein said first processed data stream includes one or more input network packets.

45. The method of claim 29 wherein said first processed data stream includes meta data.

46. The method of claim 29 wherein said first processed data stream includes one or more transformed network packets, wherein said first processing stage is further configured to generate one or more transformed network packets from the one or more input network packets.

47. The method of claim 37 wherein said second processing stage is further configured to generate classification results, wherein said classification results are included in the seventh processed data stream outputted by the second processing stage, wherein said reporting module is configured to generate a network security report using the classification results derived from the received seventh processed data stream, wherein said network security report comprises alert and logging information.

48. The method of claim 37 wherein said first processing stage is further configured to generate detection results, wherein said detection results are included in the sixth processed data stream outputted by the first processing stage, wherein said reporting module is configured to generate a network security report using the detection results derived from the received sixth processed data stream, wherein said eighth processed data stream comprises alert and logging information.

49. The method of claim 35 wherein said first processing stage is further configured to detect one or more benign input network packets, wherein said one or more benign input network packets are included in the transmitted fourth processed data stream, wherein said fourth processed data stream is transmitted to the output module.

50. The method of claim 29 wherein said first processing stage is further configured to identify the one or more input network packets as belonging to one or more streams.

51. The method of claim 50 wherein said first processing stage further comprises one or more first memory segments provided in one or more first memory devices coupled to the first processing stage, wherein said first processing stage is further configured to store the one or more input network packets belonging to one or more streams into the one or more first memory segments, wherein the one or more input network packets stored in the one or more first memory segments are included in the first processed data stream generated by the first processing stage.

52. The method of claim 35 wherein said first processing stage is further configured to identify the one or more input network packets as belonging to one or more streams.

53. The method of claim 52 wherein the stored network packets are included in the fourth processed data stream.
